(19) United States
(12) Patent Application Publication
(10) Pub. No.: US 2015/0331080 A1
(43) Pub. Date: Nov. 19, 2015

(54) Re-Entry Broadcasting Alert Apparatus, System and Method

(71) Applicant: Tommaso Sgobba, Wassenaar (NL)

(72) Inventor: Tommaso Sgobba, Wassenaar (NL)

(73) Assignee: AGENCE SPATIALE EUROPEENNE, Paris Cedex (FR)

(21) Appl. No.: 13/641,840

(22) PCT Filed: Sep. 21, 2012
(86) PCT No.: PCT/FR2012/000373

§ 371 Date: Oct. 17, 2012

(51) Int. Cl. G01S 1/68; H04H 20/59; H04H 20/71; G01S 19/13; G08B 21/02

(52) U.S. Cl. CPC G01S 1/68; G01S 19/13; G08B 21/02; H04H 20/71; H04H 20/59

(57) ABSTRACT

A re-entry broadcasting alert apparatus having a housing provided with a heat shielda connector for attaching the housing to a space system and releasing it during atmospheric re-entry thereof; a geolocalisation receiver, for determining the position of the apparatus; a processor programmed to determine a hazard area on ground and/or in airspace, where debris from the space system are expected to fall, taking the position of the apparatus as input data; and a transmitter for broadcasting a signal carrying information defining the hazard area; the geolocalisation receiver, processor and transmitter being located within the housing. A re-entry alert receiving device, cooperating with the re-entry broadcasting alert apparatus. A re-entry broadcasting alert system having a re-entry broadcasting alert apparatus and at least a re-entry alert receiving device. A method of broadcasting re-entry alerts using such a system.

The invention relates to a broadcasting apparatus, a receiving device, a system and a method for providing real-time alerts on space system returns.

Space system atmospheric re-entry represents a hazard to the public and in particular to aviation, due to surviving falling fragments. Size and shape of hazard areas are determined by space system design characteristics and operations parameters, including non-nominal behaviour due to malfunction or failure. Location of hazard areas are affected by environmental variations (atmosphere density, winds, etc.) and driven by location of space system initial fragmentation. Falling fragments trajectories uncertainties caused by variations of atmospheric density and wind effects can be taken into account by factors applied to length and width of hazard areas, but large uncertainties remain about location of hazard areas because of the lack of exact knowledge of when a space system starts re-entry, or when catastrophic collapse of a space system takes place due to re-entry heat and loads.

Non-functional space systems (e.g. spent upper stages, dead satellites) re-enter the atmosphere uncontrolled almost on a weekly basis. Currently re-entry time predictions are based on space system tracking by radar or optical equipment. Re-entry predictions can be expected to be in error by 10% to 20% or more with reference to the lapse of time between when the prediction is made and the expected re-entry. This means that, even close to the time of re-entry, the forecasts of hazard area locations may be in error of several thousand kilometres due to high re-entry speeds. Essentially there are no means nowadays for precise and timely forecasts of re-entry hazard areas locations for the case of non-functional space systems re-entry.

Suitable forecasts methods are available, instead, in case of functional space system re-entry to clear air and maritime traffic in hazard areas (i.e. traffic segregation). In the United States, following the Space Shuttle Columbia accident in 2003, a re-entry hazard areas location forecast system was put in place for the specific case of major malfunction of a Reusable Launch Vehicles (RLV) at re-entry. See the paper by D. P. Murray and M. Mitchell “Lesson Learned in Operational Space and Air Traffic Management”, 48^{th} AIAA Aerospace Sciences Meeting Including the New Horizons Forum and Aerospace Exposition, 4-7 Jan. 2010, Orlando (United States of America). The system is based on ground equipment and on software analyses and prediction tools, which require trained personnel and close coordination between the organization responsible for RLV operation and the US Federal Aviation Administration.

Document US 2004/0254697 discloses a spacecraft re-entry breakup recorder, constituted by a thermally-shielded housing releasably affixed to a spacecraft and containing a GPS receiver, sensors such as accelerometers and an emitter. The sensors and the GPS receiver acquire different kinds of data before and during the spacecraft breakup, until the separation of the recorder. Then, the collected data are transmitted while the recorder continues its free fall. This recorder can be considered the analogue of an aircraft “black box”; it allows studying the break-up process, but does not provide with a prediction or real-time determination of hazard areas.

The invention aims at providing an apparatus, system and method to broadcast real-time alerts on spacecraft re-entry. The invention can be applied, in particular, to the field of aviation security.

An object of the invention is a re-entry broadcasting alert apparatus, comprising:
a housing provided with a heat shield;
a connector for attaching said housing to a space system and releasing it during atmospheric re-entry thereof;
a geolocalisation receiver, for determining the position of the apparatus;
a processor programmed to determine the location of a hazard area on ground and/or in airspace, where debris from said space system are expected to fall, taking said position of the apparatus as input data; and
a transmitter for broadcasting a signal carrying information defining said location of said hazard area;
said geolocalisation receiver, processor and transmitter being located within said housing.

According to different embodiments:
Said geolocalisation receiver may also be for determining the positions of the apparatus at, at least, two successive times, and said processor be programmed to determine said location of said hazard area taking said positions as input data. Indeed, a single position would not lift indeterminacy on the direction of the motion of the apparatus, and therefore of debris of the space system.
The apparatus may further comprise a switch configured to activate said geolocalisation receiver, processor and transmitter upon release of the housing.
Said processor may comprise a memory storing data representative of the size and shape of a pre-computed hazard area.
Said housing may be aerodynamically shaped to stabilize during its descent.
Said connector may be configured to release said housing during breakup of the space system.

Another object of the invention is a re-entry alert receiving device, comprising a receiver, for receiving a signal broadcast by an apparatus as specified above, carrying information defining the location of a hazard area on ground and/or in airspace, where debris from a space system are expected to fall; and a processor and a display to represent said information in graphic or textual form.

Said receiving device may further comprise a geolocalisation receiver for determining its position, wherein said processor is programmed to drive the display to show a graphical representation of said hazard area and of the position of the device itself on a geographical map.

Another object of the invention is a re-entry broadcasting alert system comprising:
a re-entry broadcasting alert apparatus; and
at least a re-entry alert receiving device.

Yet another object of the invention is a method of broadcasting re-entry alerts comprising the steps of:
attaching to a space system an apparatus comprising a housing provided with a heat shield, a geolocalisation receiver, a processor and a transmitter;
releasing and activating said apparatus during atmospheric re-entry of the space system;
using the geolocalisation receiver of the apparatus to determine, in real time, its position;
using the processor of the apparatus to take said position of the apparatus as input data and determine the location of a hazard area on ground and/or in airspace, where debris from said space system are expected to fall; and
using the transmitter of the apparatus for broadcasting a signal carrying information defining said location of said hazard area, i.e. allowing to locate it in the airspace and/or on the Earth surface.

The method may further comprise using the geolocalisation receiver of the apparatus to also determine the positions of the apparatus at two successive times, and using said processor for determining a direction of motion of the apparatus from said positions, and for taking said direction of motion as input data to determine said location of the hazard area.

The method may further comprise the steps of:
receiving the signal broadcast by said apparatus; and
representing the information carried by said signal in graphic or textual form.

The term “space system” has to be understood broadly, including spacecrafts such as artificial satellites and space probes, launchers or parts thereof, etc.

Additional features and advantages of the present invention will become apparent from the subsequent description, taken in conjunction with the accompanying drawings, wherein:

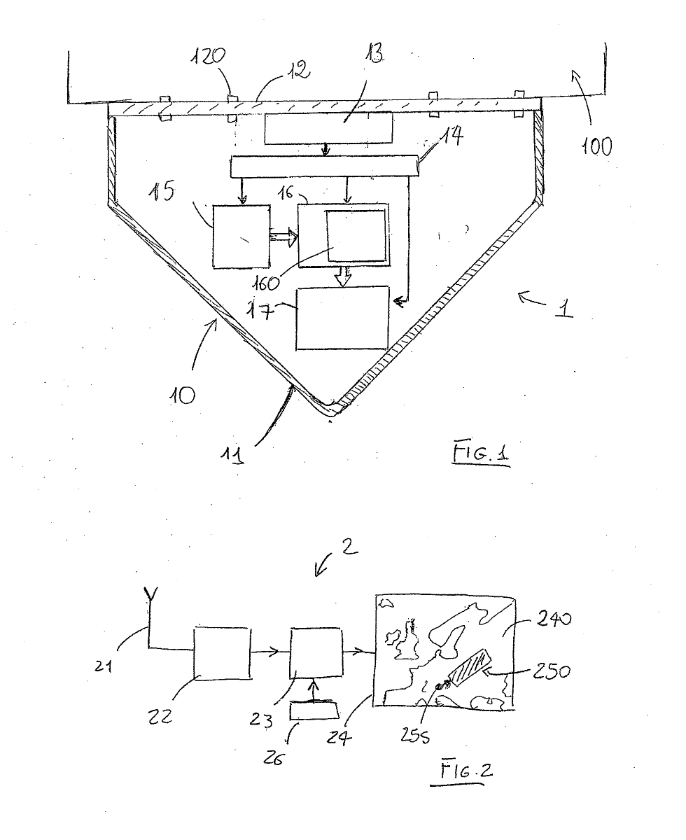

FIG. 1 shows a block diagram of a re-entry broadcasting alert apparatus according to an embodiment of the invention;

FIG. 2 shows a block diagram of a re-entry alert receiving device according to an embodiment of the invention; and

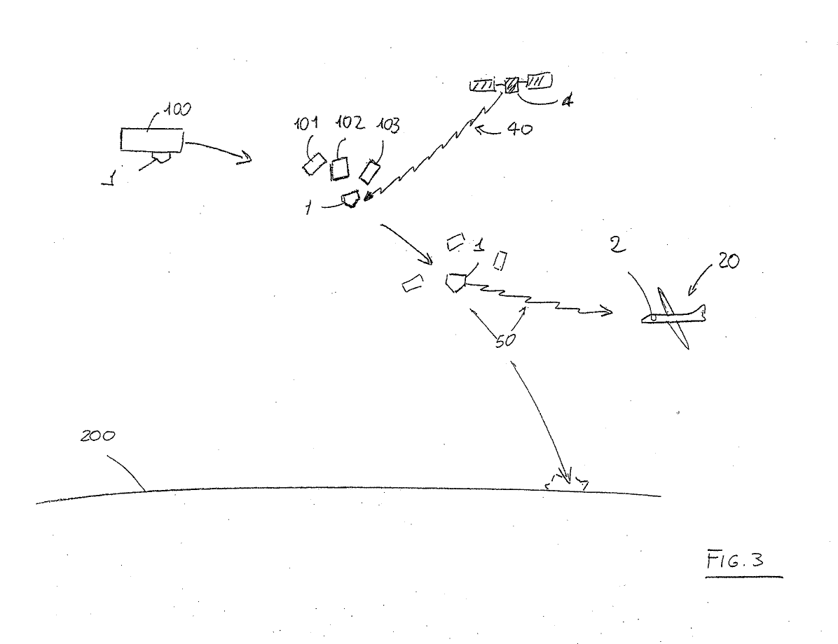

FIG. 3 illustrates the operation of a re-entry broadcasting alert system according to an embodiment of the invention.

The inventive re-entry broadcasting alert system comprises a re-entry broadcasting alert apparatus 1 and one or more receiving devices 2.

FIG. 1 illustrates the structure and operation of a re-entry broadcasting alert apparatus 1 affixed to a space system 100. The apparatus comprises an aerodynamically-shaped housing 10 with a heat shield 11 allowing it to survive atmospheric re-entry until impact to the ground, or at least for a few minutes after the breakup of the space system. The shape of the housing stabilizes it during fall through the atmosphere.

The housing is fixed to the space system by a connector 12, suitable to break during the system breakup to release the apparatus; for example, the connector may comprise bolts 120 melting or becoming brittle at a predetermined temperature reached during re-entry. The housing contains an electronic payload which is activated by a switch 13 upon the release of the apparatus (or slightly before). The switch may for example detect the achievement of a predetermined temperature or, more simply, the breaking of one or more electrical wires induced by said release. In the embodiment of FIG. 1, the switch 13 operates by turning on the power supply 13, which powers the payload. Power supply 13 has to be independent from that of the space system; therefore it should comprise batteries or other energy storing devices.

The main payload subsystems are: a geolocalisation (e.g. GPS) receiver 15, a processor 16 and a transmitter 17.

Geolocalisation receiver 15 is a conventional GPS (or equivalent, e.g. Galileo or GLONASS) positioning devices, which determines in real time the position, and advantageously also the velocity, of the apparatus. This information is provided as input data to the processor 16, which determines—also in real time—the position, shape, size and orientation of a hazard area where debris from said space system are expected to fall; for example, the processor 16 might provide as output data the geographical coordinates (latitude, longitude) of the four corners of a rectangular area, i.e. its location. For performing this task, the processor uses the data stored in a memory 160, as it will be described below; advantageously, a receiver can be provided to allow uploading data into said memory 160 from ground. The data generated by processor 16 are directly broadcast to receiving devices embarked on aircraft and ships, carried by individual users or located in ground stations.

The overall mass and drag of the apparatus are chosen such to achieve a ballistic coefficient that allows the apparatus to remain approximately in the middle of the debris cloud, and therefore of the hazard area. This optimizes the direct alert broadcasting coverage of the entire hazard area and of vicinity.

As illustrated on FIG. 2, a typical receiving device 2 comprises an antenna 21, a receiver 22 for receiving and decoding the signals broadcast by the apparatus 1, a processor 23 and a graphic display 24. The processor retrieves the information contained in the received signal and drives the graphic display to show the hazard area 250 on a geographical map. Advantageously, the receiving device also comprises a geolocalisation (e.g. GPS) receiver 26 to determine its own location (and possibly velocity), which is also represented on the graphic display. In the example of FIG. 2, the receiving device is embarked on an airplane; the position of the airplane is represented on display 24 as a dot 255, and its velocity as an arrow. It can be seen that the airplane is heading toward the hazard area 250; this information will allow the pilot to change it course to avoid it.

In simpler embodiments, the receiving device might simply display a text message, generated by processor 23 or directly carried by the received signal.

FIG. 3 illustrate in a synthetic way the operation of the inventive system. To the left of the figure, space system 100 is represented at the beginning of its re-entry, i.e. before breakup, carrying the apparatus 1. Subsequently, the space system disintegrates in several fragments 101, 102 and 103; apparatus 1 is released and behave as an additional fragment. Apparatus 1 is activated upon its release; during its fall it receives positioning signals 40 from GPS satellites 4 (only one is depicted) and broadcasts alert signals 50 to receiving devices 2, e.g. carried by airplanes 20. Finally, apparatus 1 is destroyed when it hits the Earth surface 200.

Determining the shapes and sizes of a hazard area at various altitudes is a computationally heavy task, which requires computing the trajectories of a number of debris and can hardly be performed in real time by an on-board processor. Therefore, in a preferred embodiment of the invention, said shapes and sizes are pre-computed on ground and stored in memory 160, either before the launch of the space system or at any time before its re-entry if a receiver is provided to allow the remote uploading of data into said memory. The processor 16, then, only has to determine the position and spatial orientation of said pre-computed areas with respect to apparatus 1. To do so, it needs to know the orbital inclination of the space system, which is also stored in memory 160. For example, the hazard area may be approximated by a rectangle having the same size at any altitude up to 18 km (the limit of civilian airspace). The long size of the rectangle will lay in a direction that coincides with the inclination of the space system orbit, which is stored in memory 160. For example in the case of re-entry of an Earth observation satellite (polar orbit, inclination of 90°), the long side will lie along the north-south direction with reference to the Earth surface. On-board processor 16 will get the geographical coordinates of the apparatus via the geolocalisation receiver 15 and calculate the coordinates of the corners of the rectangle, i.e. the “location” of the hazard area (two opposite corners can be sufficient). Advantageously, the geolocalisation receiver 15 will be used to determine the position of the apparatus at two different times (or more), which allows calculating the direction of motion of the apparatus, and therefore lifting any possible ambiguity on the spatial orientation of a pre-computed trajectory of the falling space system.

Some of the simplifying hypothesis considered here can be relaxed, for example the shape and/or size of the hazard zone might be considered to vary with height.

Pre-computing the shapes and sizes of a hazard area can be performed with the help of existing software tools, such as the SCARAB code developed by HTG (Goettingen, Germany) for the European Space Agency, whose structure is described in the paper by G. Koppenwallner et al. “SCARAB—a multi-disciplinary code for destruction analysis of space-crafts during re-entry”, Proceedings of the Fifth European Symposium on Aerothermodynamics for Space Vehicles, 8-11 Nov. 2005, Cologne, Germany. In SCARAB, a space system is modelled as an assembly of panel elements (volume elements are obtained by acting on the thickness of the panels), to which are associated material properties extracted from a database; the code automatically computes masses, centres of masses and moments of inertia of each element, of space system sub-assemblies and of the whole space system. The trajectory and attitude motion of the space system (and of the fragments thereof) are computed by numerical integration of the six equations of motion, taking gravity, aerodynamic pressure and shear stress as external forces and torques. Aerodynamics modelling is based on local panel methods, i.e. pressure, shear stress and heat transfer rate are calculated for each elementary surface panel; different regimes are taken into account: free molecular flow, hypersonic continuum flow, rarefied transitional flow and low speed aerodynamics. Aerodynamics modelling also accounts for aero-heating, used for thermal modelling of the space system which, in turn, allows the prediction of melting. Stresses deduced by aerodynamics modelling also serve as input data for a structural analysis, which predicts fractures in predefined cut planes. Melting and fracture analysis allow modelling the space system fragmentation; the fragment trajectories are then calculated until they impact the ground or melt completely due to aero-heating.

In an alternative, and more advantageous, embodiment, a tool as sophisticated as SCARAB is only used to generate a list of fragments with their ballistic coefficients. Then, a representative fragments subset is chosen to determine the hazard area envelop. A e.g. Gaussian distribution is then determined for each of the variable parameters affecting the fragments trajectories (altitude of explosion, atmospheric density, wind, etc.) and Monte-Carlo simulation is performed by carrying out a great number (of the order of several thousands) of calculations, using simplified tools that reconstruct trajectories and demise behaviour of the fragments subset, to generate a probabilistic hazard area. A hazard area at e.g. 10⁻⁵ is defined as an area such that there is a probability of 1 in 100,000 that a fragment may lay outside it, when accounting for all the above variables. For the sake of excluding aviation and maritime traffic, hazard areas corresponding to 10⁻² probability plus time duration for the danger are usually communicated to the relevant authorities.

1. A re-entry broadcasting alert apparatus, comprising:
a housing provided with a heat shield;
a connector for attaching said housing to a space system and releasing it during atmospheric re-entry thereof;
a geolocalisation receiver configured to determine the position of the apparatus;
a processor programmed to determine the location of a hazard area on ground and/or in airspace, where debris from said space system are expected to fall, taking said position of the apparatus as input data; and
a transmitter configured to broadcast a signal carrying information defining said location of said hazard area;
said geolocalisation receiver, processor and transmitter being located within said housing.

2. A re-entry broadcasting alert apparatus according to claim 1, wherein said geolocalisation receiver is configured to determine the positions of the apparatus at, at least, two successive times, and said processor is programmed to determine said location of said hazard area taking said positions as input data.

3. A re-entry broadcasting alert according to claim 1, further comprising a switch configured to activate said geolocalisation receiver, processor and transmitter upon release of the housing.

4. A re-entry broadcasting alert apparatus according to claim 1, wherein said processor comprises a memory storing data representative of the size and shape of a pre-computed hazard area.

5. A re-entry broadcasting alert apparatus according to claim 1, wherein said housing is aerodynamically shaped to stabilize during its descent of said housing.

6. A re-entry broadcasting alert apparatus according to claim 1, wherein said connector is configured to release said housing during breakup of the space system.

7. A re-entry alert receiving device, comprising:
a receiver configured to receive a signal broadcast by an apparatus according to claim 1, carrying information defining the location of a hazard area on ground and/or in airspace, where debris from a space system are expected to fall; and
a processor and a display configured to represent said information in graphic or textual form.

8. A re-entry alert receiving device according to claim 7 further comprising a geolocalisation receiver for determining its position, wherein said processor is programmed to drive the display to show a graphical representation of said hazard area and of the position of the device itself on a geographical map.

9. A re-entry broadcasting alert system comprising:
a re-entry broadcasting alert apparatus according to claim 1; and
at least a re-entry alert receiving device, the re-entry alert receiving device comprising
a receiver configured to receive a signal broadcast by said re-entry broadcasting alert apparatus, carrying information defining the location of a hazard area on ground and/or in airspace, where debris from a space system are expected to fall; and
a processor and a display configured to represent said information in graphic or textual form.

10. A method of broadcasting re-entry alerts comprising the steps of:
attaching to a space system an apparatus comprising a housing provided with a heat shield, a geolocalisation receiver, a processor and a transmitter;
releasing and activating said apparatus during atmospheric re-entry of the space system;
using the geolocalisation receiver of the apparatus to determine, in real time, its position;
using the processor of the apparatus to take said position of the apparatus as input data and determine the location of a hazard area on ground and/or in airspace, where debris from said space system are expected to fall; and
using the transmitter of the apparatus for broadcasting a signal carrying information defining said location of said hazard area.

11. A method of broadcasting re-entry alerts according to claim 10, comprising using the geolocalisation receiver of the apparatus to also determine the positions of the apparatus at two successive times, and using said processor for determining a direction of motion of the apparatus from said positions, and for taking said direction of motion as input data to determine said location of the hazard area.

12. A method of broadcasting re-entry alerts according to claim 10, further comprising the steps of:
receiving the signal broadcast by said apparatus; and
representing the information carried by said signal in graphic or textual form.
